(19) United States
(12) Patent Application Publication
(10) Pub. No.: US 2011/0018873 A1
(43) Pub. Date: Jan. 27, 2011

(54) TWO-DIMENSIONAL TO THREE-DIMENSIONAL IMAGE CONVERSION SYSTEM AND METHOD

(75) Inventors: CHIH-KUANG CHANG, Tu-Cheng (TW); YI-RONG HONG, Shenzhen City (CN); ZHONG-KUI YUAN, Shenzhen City (CN); LI JIANG, Shenzhen City (CN); XIAN-YI CHEN, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (SHENZHEN) CO., LTD., Shenzhen City (CN); HON HAI PRECISION INDUSTRY CO., LTD., Tu-Cheng (TW)

(21) Appl. No.: 12/730,256

(22) Filed: Mar. 24, 2010

(30) Foreign Application Priority Data
Jul. 27, 2009 (CN) 200910304845.9

(51) Int. Cl. G06T 17/00

(52) U.S. Cl. 345/420

(57) ABSTRACT

An image conversion system and method read image data of a two-dimensional image from a storage system. A data format, an image size, a pixel value of each pixel, and pixel coordinates of each pixel are determined according to the image data. A gray value of each pixel is calculated. According to the pixel coordinates and gray value of each pixel, a three-dimensional mesh is generated and then decorated, so that a three-dimensional image is obtained.

### BACKGROUND

1. Technical Field

Embodiments of the present disclosure relate to image processing technology, and particularly to an image conversion system and method for converting a two-dimensional image into a three-dimensional image.

2. Description of Related Art

Currently, image measurement machines are widely used in manufacturing to capture images of manufactured parts. However, the images captured by the image measurement machines are usually two-dimensional, and no depth information is conveyed in the images.

### BRIEF DESCRIPTION OF THE DRAWINGS

FIG. 1 is a block diagram of one embodiment of an image conversion system.

FIG. 2 is a block diagram of one embodiment of an image conversion unit of the image conversion system in FIG. 1.

FIG. 3 is a flowchart of one embodiment of an image conversion method implementing a system such as, that of FIG. 1.

FIG. 4 illustrates one embodiment of pixel coordinates of pixels in a two-dimensional image.

FIG. 5 illustrates an exemplary two-dimensional image.

FIG. 6 illustrates an exemplary three-dimensional image derived from the two-dimensional image of FIG. 5.

### DETAILED DESCRIPTION

In general, the word “module,” as used herein, refers to logic embodied in hardware or firmware, or to a collection of software instructions, written in a program language. In one embodiment, the program language may be Java or C. One or more software instructions in the modules may be embedded in firmware, such as an EPROM. The modules described herein may be implemented as either software and/or hardware modules and may be stored in any type of computer-readable medium or other storage device.

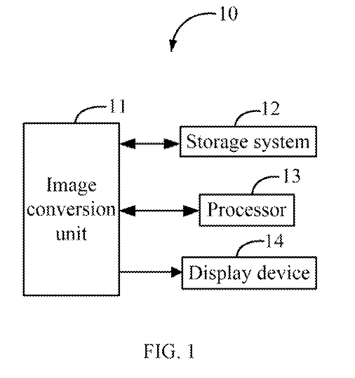

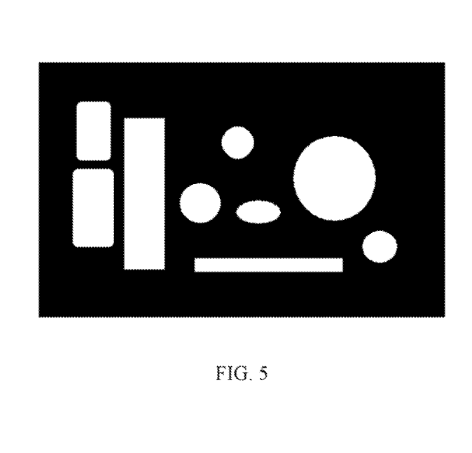

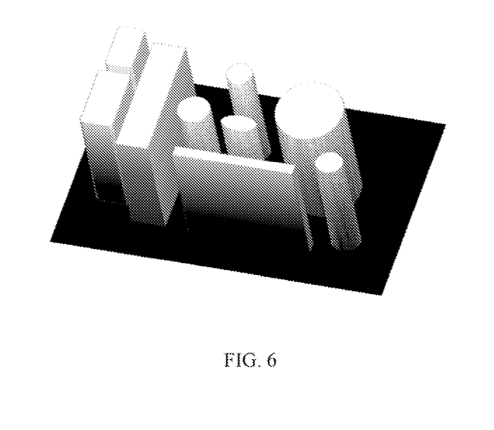

FIG. 1 is a block diagram of one embodiment of an image conversion system 10. In the embodiment, the image conversion system 10 is configured for converting a two-dimensional image (e.g., FIG. 5) into a three-dimensional image (e.g., FIG. 6). The image conversion system 10 may be a data processing device or a computerized device that can process digital images, such as a personal computer, an application server, or a workstation, for example. The image conversion system 10 may include an image conversion unit 11, a storage system 12, a processor 13, and a display device 14. One or more computerized codes of the image conversion unit 11 may be stored in the storage system 12 and be executed by the processor 13. The storage system 12 may further store image data of the two-dimensional image. In one embodiment, the storage system 12 may be a memory, a hard disk, or a compact disk. The display device 14 provides a user interface to display the two-dimensional image and the three-dimensional image.

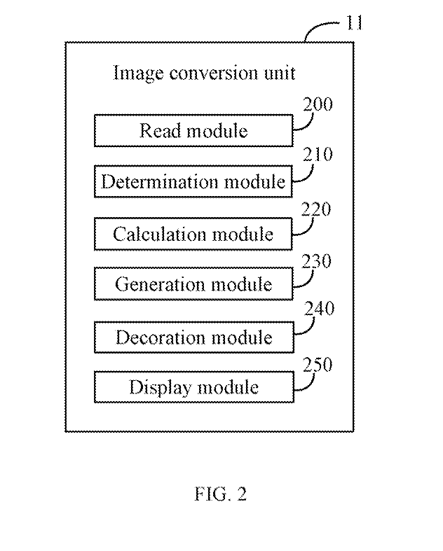

FIG. 2 is a block diagram of one embodiment of the image conversion unit 11 in FIG. 1. In one embodiment, the image conversion unit 11 may include a read module 200, a determination module 210, a calculation module 220, a generation module 230, a decoration module 240, and a display module 250.

The read module 200 reads image data of a two-dimensional image from the storage system 12, and displays the two-dimensional image on the display device 14. FIG. 5 illustrates an exemplary two-dimensional image, which is an image of a manufactured part captured by an image measuring machine. The image data may include image format information, image size information, and pixel values.

The determination module 210 determines an image format of the two-dimensional image according to the image format information, and determines an image size according to the image size information. In one embodiment, each pixel value may occupy different bits of the storage system 12 if the two-dimensional image is in different image formats. For example, if the two-dimensional image is in an 8-bit format, each pixel value may occupy 8 bits (one byte) of the storage system 12. If the two-dimensional image is in a 16-bit format, each pixel value may occupy 16 bits (two bytes) of the storage system 12.

The image size of the two-dimensional image may include a width and a height in pixels. In one example of a 60×80 two-dimensional image, the width is 60 pixels, and the height is 80 pixels.

The determination module 210 further determines a pixel value of each pixel in the two-dimensional image according to the pixel information and the image format, and determines pixel coordinates of each pixel in the two-dimensional image according to the image size. In one embodiment of a two-dimensional image in an 8-bit format, the determination module 210 may retrieve an 8-bit pixel value, such as “10001010”, for each pixel in the two-dimensional image from the pixel information.

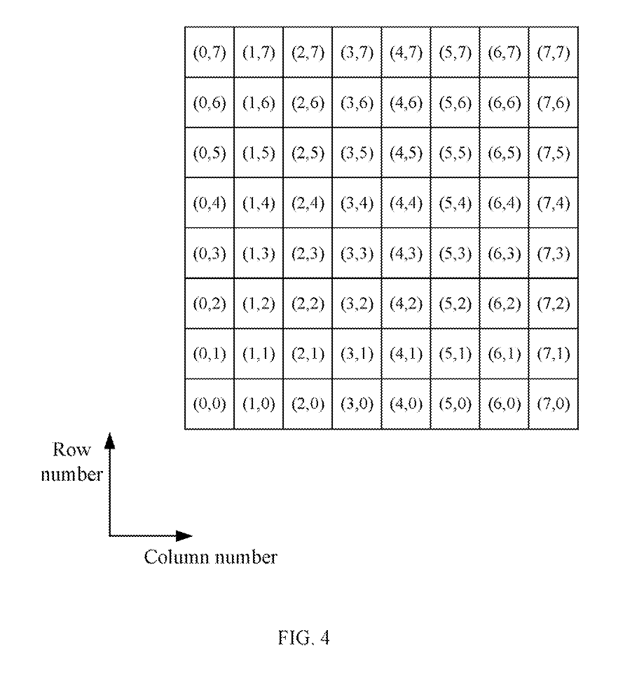

The pixel coordinates of each pixel in the two-dimensional image may be determined according to a column number and a row number of the pixel in the two-dimensional image. FIG. 4 illustrates one embodiment of pixel coordinates of pixels in an 8×8 two-dimensional image. The column number increases to the right and the row number increases upwards. Each rectangle, such as a rectangle (0, 1), denotes a pixel in the two-dimensional image.

The calculation module 220 calculates a gray value of each pixel in the two-dimensional image according to the pixel value of the pixel. In one embodiment of an RGB two-dimensional image, the pixel value of each pixel consists of a red component value, a green component value, and a blue component value. The calculation module 220 may apply a conversion formula, such as gray value=R*0.3+G*0.59+B*0.11, to calculate the gray value, wherein R, G, and B respectively represent a red component value, a green component value, and a blue component value of a pixel in the two-dimensional image.

The generation module 230 generates a three-dimensional point for each pixel in the two-dimensional image according to the pixel coordinates and the gray value of the pixel. In one example, if the pixel coordinates of a pixel are (5, 9) and a gray value of the pixel is 45, a three-dimensional point (5, 9, 45) is generated for the pixel. The generation module 230 further generates a three-dimensional mesh by connecting all the generated three-dimensional points. In one example of a 60×80 two-dimensional image, the generation module 230 generates 4800 three-dimensional points, and generates a three-dimensional mesh by connecting the 4800 three-dimensional points. The three-dimensional mesh is a three-dimensional model derived from the two-dimensional image.

The decoration module 240 decorates the three-dimensional mesh by adding surface characteristics to the three-dimensional mesh. The surface characteristics may include varied surface details such as color, texture, transparency, wrinkles, and pleats. In one embodiment, the decoration module 240 adds the surface characteristics to the three-dimensional mesh using a texture mapping method and/or a shading method.

The display module 250 displays the decorated three-dimensional mesh on the display device 14. FIG. 6 illustrates one exemplary three-dimensional image derived from the two-dimensional image of FIG. 5.

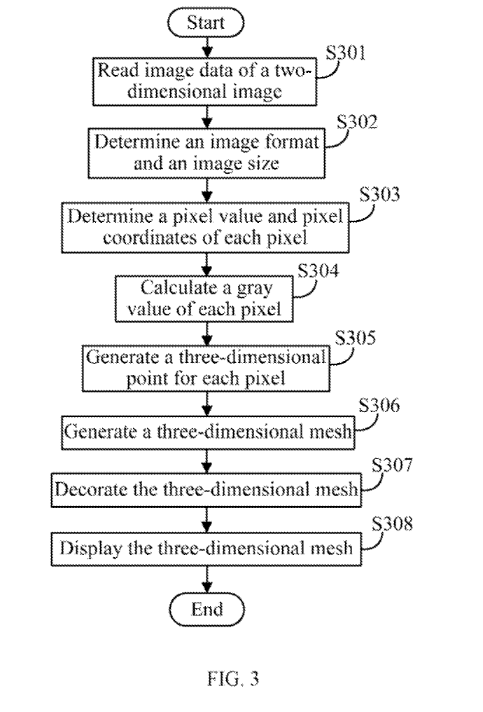

FIG. 3 is a flowchart of one embodiment of an image conversion method implementing a system such as, that of FIG. 1. Depending on the embodiments, additional blocks may be added, others removed, and the ordering of the blocks may be changed.

In block S301, the read module 200 reads image data of a two-dimensional image from the storage system 12, and displays the two-dimensional image on the display device 14. As mentioned above, the image data may include image format information, image size information, and pixel values.

In block S302, the determination module 210 determines an image format of the two-dimensional image according to the image format information, and determines an image size according to the image size information. In one embodiment, the two-dimensional image is an RGB (red, green, blue) image. The image format of the RGB image may include an 8-bit format, a 16-bit format, a 24-bit format, and a 32-bit format. Each pixel value may occupy different bits of the storage system 12 if the two-dimensional image is in different image formats. In one example, each pixel value may occupy 8 bits (one byte) of the storage system 12 if the two-dimensional image is in an 8-bit format. In another example, each pixel value may occupy 32 bits (four bytes) of the storage system 12 if the two-dimensional image is in a 32-bit format.

In one embodiment, the image size of the two-dimensional image may include a width and a height in pixels, such as a width of 60 pixels and a height of 80 pixels, for example. In other embodiments, the image size of the two-dimensional image may include a width and a height in millimeters.

In block S303, the determination module 210 retrieves a pixel value of each pixel in the two-dimensional image from the pixel information according to the image format, and determines pixel coordinates of each pixel in the two-dimensional image according to the image size. In one embodiment of a two-dimensional image in an 8-bit format, the determination module 210 may retrieve an 8-bit pixel value, such as “10001010”, for each pixel in the two-dimensional image from the pixel information. In another embodiment of a two-dimensional image in a 16-bit format, the determination module 210 may retrieve a 16-bit pixel value, such as “1000101011000101”, for each pixel in the two-dimensional image from the pixel information.

The determination module 210 may determine the pixel coordinates of each pixel in the two-dimensional image according to a column number and a row number of the pixel in the two-dimensional image. FIG. 4 illustrates one embodiment of pixel coordinates of pixels in an 8×8 two-dimensional image. In the exemplary embodiment, pixel coordinates of a pixel at the bottom left of the two-dimensional image are (0, 0), and pixel coordinates of a pixel at the top right of the two-dimensional image are (7, 7).

In block 5304, the calculation module 220 calculates a gray value for each pixel in the two-dimensional image according to the pixel value of the pixel. The pixel value of each pixel may consist of a red component value, a green component value, and a blue component value. One example of a formula to calculate the gray value may be as follows: gray value=R*0.3+G*0.59+B*0.11, where R, G, and B respectively represent a red component value, a green component value, and a blue component value of a pixel in the two-dimensional image. In another embodiment, the pixel value of each pixel in the two-dimensional image consists of a red component index, a green component index, and a blue component index. The calculation module 220 may determine a red component value, a green component value, and a blue component value corresponding to the red component index, the green component index, and the blue component index respectively. Accordingly, the gray value is calculated.

In block S305, the generation module 230 generates a three-dimensional point for each pixel in the two-dimensional image according to the pixel coordinates and the gray value of the pixel. In one embodiment of an X-Y-Z coordinate system, pixel coordinates of a pixel are defined as X-Y coordinates of a three-dimensional point, and the gray value of the pixel is defined as a Z coordinate of the three-dimensional point. For example, if pixel coordinates of a pixel are (5, 9) and a gray value of the pixel is 45, a three-dimensional point (5, 9, 45) is generated for the pixel.

In block S306, the generation module 230 generates a three-dimensional mesh by connecting all three-dimensional points corresponding to the pixels in the two-dimensional image. In one example of a 60×80 two-dimensional image, the generation module 230 generates 4800 three-dimensional points, and generates a three-dimensional mesh by connecting the 4800 three-dimensional points. In one embodiment, the three-dimensional mesh is a triangle mesh that comprises a number of contiguous triangles.

In block S307, the decoration module 240 decorates the three-dimensional mesh by adding surface characteristics to the three-dimensional mesh. As such, the three-dimensional image with a surface appearance in three dimensions is determined. The surface characteristics may include varied surface details such as color, texture, transparency, wrinkles, and pleats. In one embodiment, the decoration module 240 adds the surface characteristics to the three-dimensional mesh using a texture mapping method and/or a shading method. For example, the decoration module 240 may map a surface texture onto the three-dimensional mesh. The surface texture is a two-dimension image to be drawn on the three-dimensional mesh, each polygon in the three-dimensional mesh corresponding to a polygonal section of the surface texture.

In block S308, the display module 250 displays the decorated three-dimensional mesh on the display device 14. FIG. 6 illustrates one exemplary three-dimensional image derived from the two-dimensional image of FIG. 5.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An image conversion system, comprising:
a storage system;
at least one processor; and
an image conversion unit being stored in the storage system and executable by the at least one processor, the image conversion unit comprising:
a read module operable to read image data of a two-dimensional image from the storage system, wherein the image data comprise image format information, image size information, and pixel information;
a determination module operable to determine an image format of the two-dimensional image according to the image format information, determine an image size of the two-dimensional image according to the image size information, retrieve a pixel value of each pixel in the two-dimensional image from the pixel information according to the image format, and determine pixel coordinates of each pixel in the two-dimensional image according to the image size;
a calculation module operable to calculate a gray value of each pixel in the two-dimensional image according to the pixel value of the pixel;
a generation module operable to generate a three-dimensional point for each pixel in the two-dimensional image according to the pixel coordinates and the gray value of the pixel, and generate a three-dimensional mesh by connecting all the generated three-dimensional points;
a decoration module operable to decorate the three-dimensional mesh by adding surface characteristics to the three-dimensional mesh; and
a display module operable to display the decorated three-dimensional mesh on a display device.

2. The image conversion system of claim 1, wherein the two-dimensional image is an RBG (red, blue, green) image.

3. The image conversion system of claim 1, wherein the three-dimensional mesh is a triangle mesh.

4. The image conversion system of claim 1, wherein the determination module determines the pixel coordinates of each pixel in the two-dimensional image according to a column number and a row number of the pixel in the two-dimensional image.

5. The image conversion system of claim 1, wherein the decoration module decorates the three-dimensional mesh using a texture mapping method and/or a shading method.

6. An image conversion method, comprising:
reading image data of a two-dimensional image from a storage system, wherein the image data comprise image format information, image size information, and pixel information;
determining an image format of the two-dimensional image according to the image format information, and determining an image size of the two-dimensional image according to the image size information;
retrieving a pixel value of each pixel in the two-dimensional image from the pixel information according to the image format, and determining pixel coordinates of each pixel in the two-dimensional image according to the image size;
calculating a gray value of each pixel in the two-dimensional image according to the pixel value of the pixel;
generating a three-dimensional point for each pixel in the two-dimensional image according to the pixel coordinates and the gray value of the pixel, and generating a three-dimensional mesh by connecting all the generated three-dimensional points;
decorating the three-dimensional mesh by adding surface characteristics to the three-dimensional mesh; and
displaying the decorated three-dimensional mesh on a display device.

7. The image conversion method of claim 6, wherein the two-dimensional image is an RBG (red, blue, green) image.

8. The image conversion method of claim 6, wherein the three-dimensional mesh is a triangle mesh.

9. The image conversion method of claim 6, wherein the pixel coordinates of each pixel in the two-dimensional image are determined according to a column number and a row number of the pixel in the two-dimensional image.

10. The image conversion method of claim 6, wherein the three-dimensional mesh is decorated using a texture mapping method and/or a shading method.

11. A computer-readable medium having stored thereon instructions that, when executed by a computerized device, cause the computerized device to execute an image conversion method, the image conversion method comprising:
reading image data of a two-dimensional image from a storage system, wherein the image data comprise image format information, image size information, and pixel information;
determining an image format of the two-dimensional image according to the image format information, and determining an image size of the two-dimensional image according to the image size information;
retrieving a pixel value of each pixel in the two-dimensional image from the pixel information according to the image format, and determining pixel coordinates of each pixel in the two-dimensional image according to the image size;
calculating a gray value of each pixel in the two-dimensional image according to the pixel value of the pixel;
generating a three-dimensional point for each pixel in the two-dimensional image according to the pixel coordinates and the gray value of the pixel, and generating a three-dimensional mesh by connecting all the generated three-dimensional points;
decorating the three-dimensional mesh by adding surface characteristics to the three-dimensional mesh; and
displaying the decorated three-dimensional mesh on a display device.

12. The medium of claim 11, wherein the two-dimensional image is an RBG (red, blue, green) image.

13. The medium of claim 11, wherein the three-dimensional mesh is a triangle mesh.

14. The medium of claim 11, wherein the pixel coordinates of each pixel in the two-dimensional image are determined according to a column number and a row number of the pixel in the two-dimensional image.

15. The medium of claim 11, wherein the three-dimensional mesh is decorated using a texture mapping method and/or a shading method.
